(19) United States
(12) Patent Application Publication
(10) Pub. No.: US 2006/0193046 A1
(43) Pub. Date: Aug. 31, 2006

(54) Controllable transparence device controlled by linearly translated polarizers and method of making same

(76) Inventor: Azgad Yellin, Kfar-Saba (IL)

Correspondence Address: Martin Moynihan;c/o ANTHONY CASTORINA, SUITE 207, 2001JEFFERSON DAVIS HIGHWAY, ARLINGTON, VA, 22202, US

(21) Appl. No.: 11/066,284

(22) Filed: Feb. 28, 2005

(51) Int. Cl. G02B 27/28; G02B 5/30

(52) U.S. Cl. 359/489

(57) ABSTRACT

A controlled transparency device is presented. The device is operable to control a ratio of light transmitted by the device to light blocked by the device. Control is achieved by linear translation of a first polarizing layer with respect to a second polarizing layer. In a preferred embodiment, each of the first and second polarizing layers comprises a plurality of polarizing areas of standard width, wherein polarization orientation of each area on layer differs from the polarization orientation of an adjacent area by a standard angular difference. The device is usefully embodied as a window, a space divider for open-space offices, a curtain wall, a sun visor for a vehicle, a visor for welding, adjustable sunglasses, and a controllable dimmer for a mirror such as the rear-view mirror of a vehicle.

### FIELD AND BACKGROUND OF THE INVENTION

The present invention relates to a controllable transparence device and a method of making same. More particularly the present invention relates to a device having two polarizing layers operable to be linearly translated one with respect to the other, which can be used to control transmittance of light or heat through the device. The device can be used to make a controllably transparent window, a controllable light-blocking or heat-blocking device, an adjustable sun visor for a vehicle, an adjustable visor for welding, light-adjustable dimmers for rear view mirrors for vehicles, adjustable sunglasses, and various other applications.

Various devices have been used to control light and/or heat transmittance through windows and openings of various sorts.

Most familiar are window shades, venetian blinds, and various other devices where portions of a transparent surface are rendered opaque in order to controllably adjust the degree of light or heat transmittance of an otherwise transparent surface such as a glass window. Such devices control light transmittance by hiding and rendering opaque a portion of the window, either by completely obscuring a large part of that window (e.g., a window shade), or by interspersing opaque and transparent sections along the surface of a window, and manipulating relative size of those opaque portions with respect to those transparent portions (e.g., venetian blinds). Although these devices are of course useful and popular in many contexts, they have the disadvantage that, when used to control light transmittance through a window, they also interrupt the view through that window. Thus, there is a widely recognized need for, and it would be highly advantageous to have, a device operable to control light transmittance through a window or similar opening, which device enables controlled partial limitation of light transmittance without interposing opaque objects which prevent continuous viewing through that window.

Moreover, venetian blinds, when compared to the present invention presented hereinbelow, may be seen to be a relatively complex device, requiring as they do rotation of objects through a three-dimensional space. With respect, for example, to pre-sealed windows or curtain walls containing mechanically manipulatable venetian blinds, it is well known that the mechanical linkages used to control the blinds typically fail long before the window fails in other aspects of its functionality. Thus, there is a widely recognized need for, and it would be highly advantageous to have, a device operable to control light transmittance through a window or similar object, which device is mechanically simpler and easier to maintain than are venetian blinds. This need is particularly acute with respect to various specialized types of windows, such as aircraft windows, ship windows, personnel space dividers used in “open space” offices, etc.

Sunglasses and partially silvered or tinted mirrors are widely used to provide limited or partial transmittance of light, yet such devices are typically not adjustable in terms of degree of light transmittance, and provide light which is often too bright or too dim for comfort and convenience of their users. Since the devices are not adjustable and conditions of their use vary, users are often obliged to view scenes through optical devices which cause them either to suffer discomfort and danger of excessive light, or to peer with difficulty at dim scenes whose details are rendered unclear because of their obscurity. Thus there is a widely recognized need for, and it would be highly advantageous to have, sunglasses, mirrors, and similar optical devices which permit a user to adjustably control the devices' light transmittance to suit his convenience and comfort for a variety of tasks and in a variety of lighting conditions.

Polarizing filters have been used to control light transmittance. As is well known, a pair of polarizing filters can be used to block light transmittance over a continuously variable range. When two polarizing filters are similarly aligned, their blockage of light is at a minimum. In simplified theory, this minimum is 50% of the incident light, since light components perpendicular to the angle of orientation of the polarizers are blocked. (In practice, due to inefficiencies and various losses, the minimum is somewhat more than 50%.) Two polarizing filters oriented one at right angles to another will block most of the incident light. Theoretical maximum blockage is of 100%, although in practice maximum blockage tends to be a bit less than 100%. Further, as is well known, rotation of one polarizer with respect to the other through an angle greater than zero and less than a right angle will produce a partial blockage of transmittance, which blockage is a continuous function of that angle of rotation. Thus, a construction having two polarizing layers controllably rotatable one with respect to the other is capable of controlled partial light blockage over the range of transmittances between that minimum and that maximum. Unfortunately, most applications for controlled partial light transmittance do not conveniently allow for rotation of one polarizer with respect to another, for the simple reason that most human applications for selective partial light transmittance have to do with rectangular objects, such as windows, wall segments, mirrors, eyeglasses, sun visors, etc. For most applications, there is no convenient way to rotate one polarizer with respect to another, without either requiring a large amount of extra space to accommodate the rotating polarizers outside the rectangle of the light transmitting surface, or else limiting users to circular light-transmitting surfaces, which limitation is rarely convenient. Thus, there is a widely recognized need for, and it would be highly advantageous to have, a device operable to control light transmittance of a window or similar object using polarizing surfaces to provide partial light blocking to a controllable degree, which device does not require rotation of one polarizing surface with respect to the other to modify the degree of transmittance of the device.

In many contexts, variable control of heat transmittance is highly desirable. Much power is required to heat buildings in winter and to cool buildings in summer. Thus, a surface operable to block heat transmittance when desired, and to permit heat transmittance when desired, would be highly useful. In particular, modern high-rise construction styles featuring large transparent glass or similar surfaces, are typically not adaptable to changing conditions of heat and cold, as between winter and summer, or day and night. The few “green” buildings recently designed and constructed which do provide curtain walls with controlled partial heat/light transmittance accomplish this using venetian blinds technology, with attendant space requirements, mechanical complexity, and maintenance requirements. Thus there is a widely recognized need for, and it would be highly advantageous to have, transparent or semitransparent surfaces operable to be adjusted to controlled varying degrees of transmittance of infra-red and/or ultraviolet light, while yet providing shaded but continuous uninterrupted viewing therethrough.

### SUMMARY OF THE INVENTION

According to one aspect of the present invention there is provided a controlled transparency device operable to control a ratio of incident light transmitted by the device to incident light blocked by-the device, comprising: a first polarizing layer, a second polarizing layer, and a mechanism for translating the first and/or the second polarizing layers longitudinally with respect to one another, so as to control the ratio of the incident light transmitted by the device to the incident light blocked by the device. Preferred embodiments include the device embodied as a window such as an aircraft window or a marine vessel window, the device embodied as a space divider for “open space” office environments, the device embodied as a curtain wall, the device embodied as a visor for welding, the device embodied as a dimmer for a mirror, such as a rear-view mirror of a vehicle, and the device embodied as a sun visor for a vehicle.

According to further features in preferred embodiments of the invention described below, each of the first and second polarizing layers comprises a plurality of polarizing areas of equal width, and wherein polarization orientation of each of the areas on each of the first and second layers differs from polarization orientation of an adjacent area by a standard angular difference. The device preferably comprises a stopping mechanism whereby movement of the first layer with respect to the second layer is arrested at positions wherein an area of the first layer is aligned with an area of the second layer.

The standard width of the polarizing areas may be smaller than 2 mm, and may be such that if a light source is present on a first side of the device and if areas of the first layer are so positioned as to be misaligned with areas of the second layer, light and dark patterns thereby created by the device are too small to be resolved by a human eye positioned at anticipated user distance on a second side of the device.

The areas may be formed as rectangular strips, as curved strips, and as parallelograms.

According to further features in preferred embodiments of the invention described below, each of the first and second polarizing layers comprises a polarizing surface of continuously variable polarization orientation, such that if the first and second layers are described in a Cartesian space in which an x axis corresponds to the direction of longitudinal translation of the first layer with respect to the second layer, and A1 is a point on one of the first and second layers positioned at x1,y1 having a polarization orientation at angle P1, A2 is a point on one of the first and second layers positioned at x2,y2 having a polarization orientation at angle P2, A3 is a point on one of the first and second layers positioned at x3,y3 having a polarization orientation at angle P3, A4 is a point on one of the first and second layers positioned at x4,y4 having a polarization orientation at angle P4, P1 and P2 being on a same one of the first and second layers and P3 and P4 being on a same one of the first and second layers, then for all selections of points such that (x2−x1)=(x4−x3), angular difference (P2−P1) equals angular difference (P4−P3).

According to yet further features in preferred embodiments of the invention described below, the mechanism comprises a lever or wheel usable to effect translation of the first layer with respect to the second layer.

According to additional features in preferred embodiments of the invention described below, the device comprises a motor usable to effect translation of the first layer with respect to the layer. The motor is operable to be controlled by a controller which may be operable to receive data from a user or from a sensor, and further operable to select a command for the motor, the selection being at least partially based on the received data. Preferably, the device comprises at least one sensor, and optionally a plurality of sensors, which sensors may include a heat sensor and/or a light sensor.

The first layer may be rigid and at least a portion of the second layer flexible. Alternatively, the first and second layers may rigid. Further alternatively, at least a portion of the first layer is flexible and at least a portion of the second layer is flexible. Each of the first and second layers may comprise a flexible portion operable to be rolled on a roller.

The device may be embodied as a sealed window.

According to additional features in preferred embodiments of the invention described below, the flexible portion is operable to be rolled on a roller operable to be rotated by a user or by a motor controlled by a user or controlled by a user by means of a wireless remote control.

According to another aspect of the present invention there is provided a method of manufacturing a controlled transparency device operable to control a ratio of incident light transmitted by the device to incident light blocked by device, the method comprising assembling a first polarizing layer; a second polarizing layer; and a mechanism for translating the first and/or said second polarizing layers longitudinally with respect to one another, so as to control the ratio of the incident light transmitted by the device to the incident light blocked by the device, thereby manufacturing the controlled transparency device operable to control the ratio of the incident light transmitted by the device to the incident light blocked by device.

According to further features in preferred embodiments of the invention described below, the method of manufacturing a controlled transparency device further comprises providing on each of the first and second polarizing layers a plurality of polarizing areas of equal width, polarization orientation of each of the areas on each of the first and second layers differing from polarization orientation of an adjacent area by a standard angular difference.

According to still further features in preferred embodiments of the invention described below, the method further comprises providing a stopping mechanism for arresting movement of the first layer with respect to the second layer at positions wherein an area of the first layer is aligned with an area of the second layer.

Alternatively, the method may comprise providing on each of the first and second polarizing layers a polarizing surface of continuously variable polarization orientation, such that if said first and second layers are described in a Cartesian space in which an x axis corresponds to the direction of longitudinal translation of the first layer with respect to said second layer, and

A1 is a point on one of the first and second layers positioned x1, y1 having a polarization orientation at angle P1,

A2 is a point on one of the first and second layers positioned at x2, y2 having a polarization orientation at angle P2,

A3 is a point on one of the first and second layers positioned at x3, y3 having a polarization orientation at angle P3,

A4 is a point on one of the first and second layers positioned at x4, y4 having a polarization orientation at angle P4,

P1 and P2 being on a same one of the first and second layers and P3 and P4 being on a same one of the first and second layers,

then for all selections of points such that (x2−x1)=(x4−x3), angular difference (P2−P1) equals angular difference (P4−P3).

According to still further features in preferred embodiments of the invention described below, the method further comprises providing a motor usable to effect translation of the first layer with respect to the second layer, and optionally providing a controller operable to control operation of the motor and further operable to receive input from at least one of a group consisting of a human operator, an infrared sensor, a visible light sensor, and an ultra-violet light sensor.

Preferably, the method further comprises embodying the controlled transparency device in one of a group consisting of a window, a sealed window, a space divider for office buildings, a curtain wall, a visor for welding, a dimmer for a mirror, and a sun visor for a vehicle.

The present invention successfully addresses the shortcomings of the presently known configurations by providing a device operable to control light transmittance through a window or similar opening, which device enables controlled gradual limitation of light transmittance without interposing opaque objects which prevent continuous viewing through the window.

The present invention further successfully addresses the shortcomings of the presently known configurations by providing a device operable to control light transmittance through a window or similar opening, which device is simpler and easier to maintain than are venetian blinds.

The present invention further successfully addresses the shortcomings of the presently known configurations by providing sunglasses, mirrors, and similar optical devices which permit a user to adjustably control the devices' light transmittance to suit his convenience and comfort for a variety of tasks and in a variety of lighting conditions.

The present invention further successfully addresses the shortcomings of the presently known configurations by providing a device operable to control light transmittance of a window or similar object using polarizing surfaces to provide partial light blocking to a controllable degree, yet which does not require rotation of one polarizing surface with respect to the other to change degree of light transmittance of the device.

The present invention yet further successfully addresses the shortcomings of the presently known configurations by providing transparent or semitransparent surfaces operable to be adjusted to controlled varying degrees of transmittance of infra-red and/or ultraviolet light, while yet providing a shaded but continuous uninterrupted viewing therethrough.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic of a controllably variable light blocking device, according to an embodiment of the present invention;

FIGS. 2a and 2b are simplified schematics showing two exemplary relative positions of first and second layers of a controllably variable light blocking device, resulting in different levels of light transmittance, according to an embodiment of the present invention;

FIG. 3 is a simplified schematic of an additional embodiment of a controllably variable light blocking device, according to an embodiment of the present invention;

FIG. 4 is a simplified schematic of a sealed window providing controlled light transmittance, according to an embodiment of the present invention;

FIG. 5 is a simplified schematic showing a controllably variable light blocking device embodied as a sun visor for a vehicle;

FIG. 6 is a simplified schematic showing a controllably variable light blocking device embodied as a welding helmet visor;

FIGS. 7a and 7b are a simplified schematics showing a controllably variable light blocking device embodied as a mirror dimmer for a rear-view mirror of a motor vehicle; and

FIG. 8 is a simplified schematic showing a controllably variable light blocking device embodied as pair of light-transmittance adjustable sunglasses.

### DESCRIPTION OF THE PREFERRED EMBODIMENTS

The present invention is of a controllable partial transparence device in which two polarizing layers operable to be linearly translated one with respect to another are used to control transmittance of light or heat through the device. Specifically, the device can be used to make a controllably transparent window, a controllable light-blocking and/or heat-blocking device, a controllable light or heat absorption device, and an adjustable sun visor for a vehicle, mirrors and sunglasses with controllable light transmittance, and similar optical devices. The present invention is also of a method of making the device.

The principles and operation of embodiments of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried, out in various ways. Also, it is to be understood that the phraseology and terminology employed herein is for the purpose of description and should not be regarded as limiting.

To simplify the following descriptions, reference in some cases is made to control of transmittance of “light” through the described devices. It is to be noted that the word “light” as used herein is generally to be understood to include both ultraviolet light and infra-red radiation, unless the ideational context (e.g., a discussion of a user's ability to see through a device) implies that reference is made specifically to frequencies of visible light. The devices described hereinbelow may be used to control transmittance of visible light, and/or of infra-red radiation, and/or of ultraviolet light, though it is understood that the polarizing filters employed may be optimized for one or another range of light frequencies, as required for a particular application or as dictated by considerations of cost or efficiency.

In the following, reference is made to two layers of a device being “translated” one with respect to another. To avoid any ambiguity it is noted that a first layer “translated” with respect to a second layer is to be understood to be moved, longitudinally, in a selected direction, in a plane substantially parallel to the plane of that second layer. Use of the term “translated” is intended particularly to distinguish the device of the present invention from prior art devices wherein one polarizing layer is rotated with respect to another.

It is expected that during the life of this patent new types of windows may be developed. The scope of the term “window” is intended to include all such new technologies a priori.

As used herein the terms “about” and “approximately” refer to ±10%.

In discussion of the various figures described hereinbelow, like numbers refer to like parts.

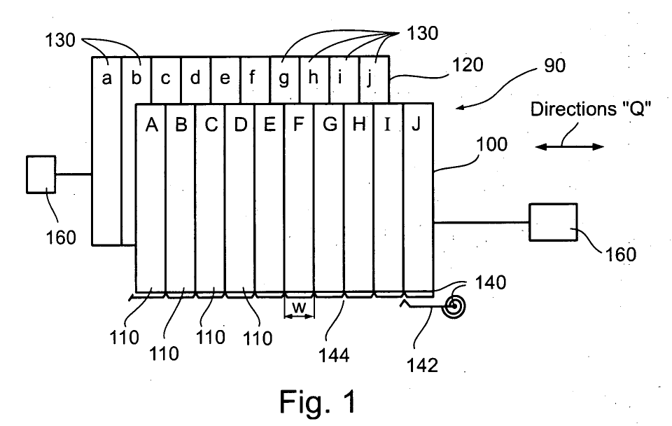

Referring now to the drawings, FIG. 1 is a simplified schematic of a controllably variable light blocking device 90, according to an embodiment of the present invention. Device 90 is also referred to herein as a controlled transparency device. Device 90 is operable to control a ratio of incident light transmitted by device 90 to incident light blocked by device 90.

Device 90 comprises a first polarizing layer 100, a second polarizing layer 120, and a mechanism (shown in FIGS. 4, 5, 7b, and 8) for translating first polarizing layer 100 longitudinally with respect to second polarizing layer 120. As will be described in detail hereinbelow, longitudinal translation of polarizing layer 100 with respect to polarizing layer 120 serves to control the ratio of the incident light transmitted by device 90 to the incident light blocked by device 90.

Each of polarizing layers 100 and 120 comprises a plurality of polarizing areas of equal width. Polarization orientation of each area differs from polarization orientation of an adjacent area by a standard angular difference. As will be shown hereinbelow, linear translation of polarizing layer 100 with respect to layer 120 enables control of light-transmittance of device 90.

As shown in FIG. 1, layer 100 comprises a plurality of polarizing areas 110, marked A, B, C, D, E, F, G, etc. In a preferred embodiment areas 110 are embodied as relatively tall and thin rectangular strips as shown in FIG. 1, but it is to be understood that the appellation “areas 110” is not intended to imply limitation to the precise form shown in FIG. 1. Areas 110 may be embodied in a variety of forms, as discussed hereinbelow.

Areas 110 are characterized by a same width W, and are further characterized by the fact that a constant angular difference K (referred to as a “standard angular difference” in the claims) exists between the polarization orientation of each area 110ₙ and an adjacent area 110ₙ₊₁. Thus if, for example, area 110A were oriented at an angle of, say, 10° to the vertical, and area 110B were oriented at 20° to the vertical, then area 110C would be oriented at 30°, area 110D at 40°, area 110E at 50°, and so on. In general, on a given layer 110, the difference K in angular orientation between any area 110ₙ and an adjacent area 110ₙ₊₁ will be a constant. In the example presented in this paragraph, K=10°.

Layer 120 is similar to layer 100. Layer 120 comprises a plurality of polarizing areas 130, marked a, b, c, d, e, f, g, etc. in FIG. 1. Areas 130 are also characterized by common width W. That is, the width of each area 130 is W, and therefore identical to the width of areas 110. Further similarly, a constant angular difference exists between the polarization orientation of each area 130ⱼ and adjacent area 130_{j+1,} and that angular difference is also equal to K, the angular difference between orientations of adjacent areas 110. The angular difference which characterizes the pair 110ₙ and 110ₙ₊₁ also characterizes the pair 130ⱼ and 130ⱼ₊₁ for any n and for any j. Recalling our previous example, if area 110A were oriented at an angle of 10° to the vertical, area 110B were oriented at 20° to the vertical, area 110C at 30°, area 110D at 40°, area 110E at 50°, and so on, then the difference between each area 130ⱼ and an adjacent area 130ⱼ₊₁ would also be 10°.

Orientation of area 130a may be identical to that of area 110A, or it may be different. Depending on intended use and on manufacturing considerations, it may be convenient for layer 100 and layer 120 to be identical, or for them to differ by a constant difference. For example, if layer 100 has area 110A oriented at 10°, area 110B oriented at 20°, 110C at 30°, 110D at 40°, etc., it might be found convenient for certain applications, for reasons to be discussed hereinbelow, for layer 120 to have area 130a oriented at 40°, area 130b oriented at 50°, 130c at 60°, 130d at 70°, etc.

Layer 100 and/or layer 120 may be implemented as a rigid panel, such as would be obtained if polarizing filter material were mounted on a glass or rigid plastic substrate, or as a flexible layer, as would be obtained if polarizing filter material were mounted on a flexible substrate such as Mylar® (Registered trademark of DuPont Teijin Films). An alternate useful implementation is a combined configuration in which a rigid or semi-rigid central section of a layer 100 or 120 is joined to flexible portions at its extremities. Such a configuration might be useful for an implementation such as is presented in FIG. 4, discussed hereinbelow.

To enhance clarity of FIG. 1, layers 100 and 120 have been shown slightly distanced one from another, yet layers 100 and 120 are preferably constructed close or adjacent to one another, to minimize parallax.

Layers 100 and 120 are mounted in a framework (not shown in FIG. 1) which enables layers 100 and 120 to be translated laterally with respect to one another. Lateral translation (i.e. lateral movement) takes place in directions referred to herein as “directions Q”. Width W of areas 110 and 130 is measured along direction Q. Thus if, for example, layers 100 and 120 are initially positioned such that area 110A is aligned with area 130d, and layer 100 is then translated (moved) in a direction Q (e.g. to the right or to the left, as shown in FIG. 1) by a distance W, then area 110A would then be well aligned with a different area 130 of layer 120, namely area 130e if layer 120 were moved to the right, or 130c if layer 120 were moved to the left. Of course, in this arrangement it is relative motion of layers 100 and 120 which is important: moving layer 120 by distance W to the right would produce the same effect as moving layer 100 by distance W to the left.

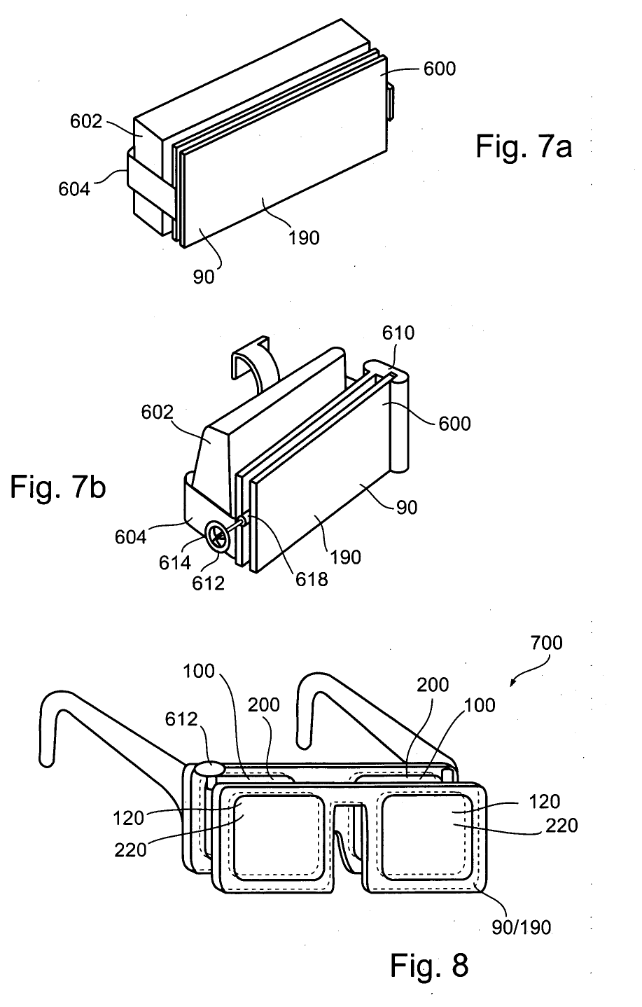

Examples of frameworks permitting such motion are shown hereinbelow in reference to FIG. 4 and to FIG. 7b, yet any well-known arrangement allowing one object to roll or slide along another object may be used. Lateral movement of layer 120 with respect to layer 100 may be accomplished manually, and a lever, rack and pinion arrangement, or other mechanical facilitating device (not shown in FIG. 1) may be provided to facilitate such movement. Alternatively, one or more motors 160 may be provided to move one layer with respect to the other. In embodiments where width W is small, an accurate positioning device such as a stepper motor may be used. Such embodiments will be discussed hereinbelow.

Optionally, a stopping mechanism 140, such as spring 142 and slots 144, may be provided to facilitate positioning of layer 130 with respect to layer 110 at a variety of relative positions selected such that in each such position areas 130 are well aligned with areas 110, and borders between areas 130 line up with borders between areas 110. Where areas are so aligned, a viewer looking through device 90 sees light passing through each individual area 110 through a single individual area 130. A stopping mechanism facilitating alignment of areas 110 with areas 130 is preferable in various embodiments of the present invention, yet is not a requirement of device 90 in general. As will be shown hereinbelow, for small values of W and small values of K, strict alignment of areas 110 with areas 130 may be unnecessary.

It is to be understood that device 90 may be constructed with any number of areas 110 and 130, and that changes in angles of orientation of areas 110 and 130 across layers 100 and 120 may come to less than 360°, or to more than 360°. Of course, if K is so selected that 360° is evenly divisible by K, then the structure of areas 110 and 130 will by cyclically repeatable, and a same pattern of areas 110 and 130 may be cyclically repeated across layers 100 and 120 to any desired width.

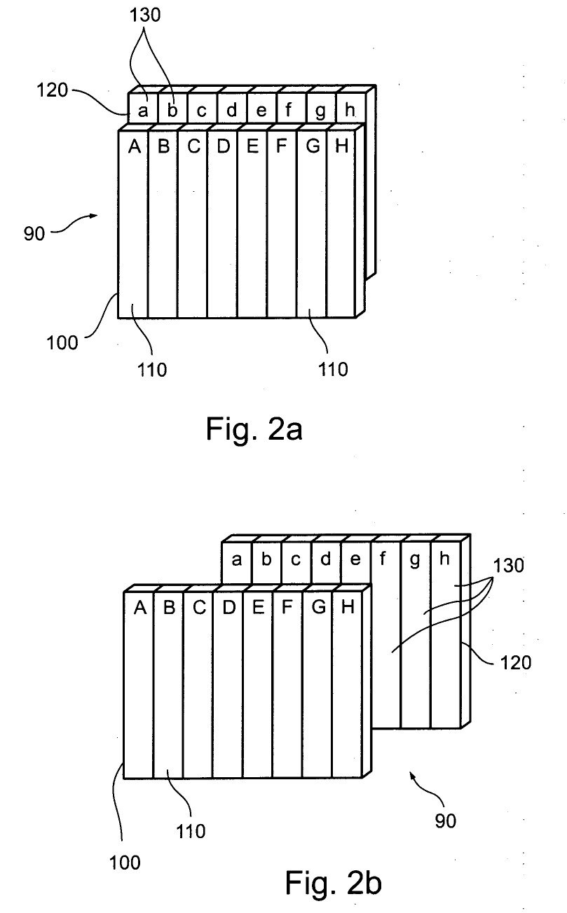

FIG. 1 presents areas 110 and 130 as vertically oriented rectangular strips, in an embodiment in which layers 100 and 120 are operable to be moved horizontally one with respect to the other. It is to be understood that other configurations are possible. Areas 110 and 130 may be horizontal strips and layers 100 and 120 movable vertically. Areas 110 and 130 may be diagonal, may be formed as parallelograms or as curves, and may have other regular or irregular forms. If the basic characteristics of areas 110 and 130 are present, particularly a common width W in a direction Q which is the direction of translation of layer 100 with respect to layer 120, and a common difference K in polarization orientation angle from one area 110 to another and from one area 130 to another along that direction of translation Q, then device 90 is useable to controllably block or transmit light through a range of possible transmittance values, as will be shown with reference to FIGS. 2a and 2b.

Attention is now drawn to FIGS. 2a and 2b, which present simplified schematics showing two exemplary relative positions of layers 100 and 120 of device 90, resulting in different levels of light transmittance.

Assume, as an example of a possible configuration of device 90, that layer 100 and layer 120 are identically constructed, with both area 110A and area 130a being oriented at 10° to the vertical, and that K=10°. FIG. 2a presents a position of layer 120 with respect to layer 100 such that area 110A is aligned with area 130a, area 110B is aligned with area 130b, area, 110C with area 130c, and so on across the width of device 90.

In the case presented in FIG. 2a, polarization orientation of each area 130 is identical to the orientation of that area 110 with which it is aligned. For example, area 110C will be oriented at 30° to the vertical, as will area 130c. Thus a person looking through the lined-up pair of areas 110C and 130c will see a maximum amount of light transmitted by device 90, that amount being 50% of the impinging on device 90, minus whatever inevitable losses are generated by inefficiencies in light conduction through the polarizing materials and their substrates.

FIG. 2b presents the device of FIG. 2a, where layer 130 has been translated sideways with respect to layer 110 so that area 130a is now aligned with area 110A, area 130b is now aligned with area 110E, area 130c is now aligned with area 110F, and so on across the width of device 90.

According to our assumptions, area 130a is oriented at 10° from the vertical, while area 110D is oriented at 40° from the vertical. Thus, there are 30° of difference between the orientations of the two aligned areas, and part of the light directed therethrough is accordingly blocked. Similarly, area 130b is oriented at 20° from the vertical and area 110E is oriented at 50°, the difference between this pair is also 30°. Thus, as may be seen from examining FIG. 2b, each area on layer 100 aligns with an area on layer 120 whose orientation differs by 30°. Consequently, light is blocked, by, each pair of areas to a same degree across all the width of device 90. If layer 120 is further translated sideways with respect to layer 100, so that, say, area 130a aligns with area 110F, polarization orientations of areas 130a and 110F will differ by 50°, as will that of every other pair of areas across the width of device 90, and yet more light will be blocked. Thus, by sliding or otherwise translating layer 120 with respect to layer 100 in direction Q, a great variety of desired combinations of polarization orientations can be established across the width of device 90, thereby achieving a goal of multiposition stepwise control of transmittance of device 90 through a range extending from a maximum transmittance, when orientations of areas 110 and areas 130 are identical, to a minimum of zero or near-zero transmittance, when orientations of areas 110 are perpendicular to orientations of areas 130.

Several alternative constructions may be noted.

As noted, translation of one of layers 100 and 120 with respect to the other creates configurations with varying degrees of transmittance of light and heat. For some uses it may be convenient to assign polarization orientations in such a manner that combinations of areas 110 and 130 which occur when layers 100 and 120 are aligned as shown in FIG. 2a produce transmittance somewhere near the middle of the minimum/maximum range of device 90, rather than the assignment shown in FIG. 2a, wherein device 90 is at one extreme of its range (maximum transmittance) when layers 100 and 120 are so aligned.

For certain uses it may be found that only particular combinations of positions are desirable, for example positions enabling only relatively high percentages of light blockage, or positions alternating only between substantially transparent and substantially opaque.

Choice of an appropriate width W for areas 110 and 130 depends, among other things, on convenience in manufacturing. If areas 110 and 130 are manufactured by a mechanical process, such as attaching individually cut polarizing areas onto a substrate, it will presumably be convenient to use areas of a width which can be easily handled. However, processes have recently been developed which enable polarizing films to be printed or otherwise formed on a substrate in a highly configurable digitally designed format. For example, American Polarizers Inc., of 141 S. 7th St. Reading, Pa. 19602 U.S.A. has commercialized a method for ‘printing’ polarizing panels in a variety of detailed designs. Their method is capable of great detail and extremely fine resolution. Using such methodologies, it is possible to reduce W (and K) to very small dimensions while creating a large number of areas, each slightly differentiated from its neighbors. Such a configuration comports several advantages. The construction as described in the example above, with 10° of difference between areas, requires, for optimal viewing, exact alignment of areas 110 and 130: If there exists some inexactitude of alignment between areas 130 and 110, or if some portion of an area 130 is inadvertently seen through a portion of an inappropriate area 110 (e.g. because of parallax, areas 110 and 130 being necessarily somewhat distanced from one another), then those portions of areas 130 seen through inappropriate areas 110 will appear either lighter or darker (depending on which side overlaps) than the major portions of areas 110 and 130 which are aligned appropriately. In other words, inexactness of matching of areas 110 and 130 may produce a plurality of light or dark vertical lines across device 90. If, however, using techniques of American Polarizers Inc., or similar techniques, layers 110 and 130 are produced having a very fine resolution (small W) and highly gradual gradations of polarization orientation (small K), it is possible to reduce the dimensions and spacing of such light or dark vertical lines to such an extent that they cannot be resolved by the human eye. At that point, it no longer becomes necessary to avoid creating of such vertical lines, because the differences in brightness of light transmitted on and that transmitted between the lines would approach zero, and the width and separation of such lines would approach zero as well. Under sufficiently fine resolution, differences between ‘appropriate’ and ‘inappropriate’ alignment would become indistinguishable to a viewer. In other words, device 90 would function as a continuously variable device, for which there would be no need to utilize an alignment device such as stopping mechanism 140 of FIG. 1 to align areas 110 and areas 130, since any relative position of areas 110 and 130 would produce what would appear to a human viewer to be a smooth, continuous, and continuously variable partial blocking of light transmitted through device 90.

It is further noted that although FIG. 1 presents areas 110 and 130 as extending in length from top to bottom of device 90, this configuration is not a necessary feature of device 90. Device 90 may be constructed with a plurality of sets of areas 110 and 130, each set constructed as defined hereinabove, and each set positioned at a different height (as measured in a direction perpendicular to direction Q) on device 90. Such sets can be discontinuous from each other with respect to positioning of borders between their areas 110 (and/or 130). Such a configuration might be used to advantage in an embodiment of device 90 having a very fine resolution (small W) and highly gradual gradations of polarization orientation (small K), as presented in the preceding paragraph. Sets of areas 110 and 130, each set self-consistent according the descriptions presented hereinabove, yet positioned at different heights and configured so that their borders between areas 110 and/or 130 are at differing lateral positions, would further enhance the appearance of a smooth and continuous partial blocking of light when layers 100 and 120 are arbitrarily positioned with respect to each other, because patterns of light and dark formed when areas 110 and areas 130 are misaligned would not then form continuous lines.

In a preferred embodiment of the present invention there is provided a method for manufacturing controlled transparency device 90. Controlled transparency device 90 may be manufactured by assembling a first polarizing layer 100, a second polarizing layer 120, and a mechanism for longitudinally translating first layer 100 with respect to second polarizing layer 120. Layers 100 and 120 may be rigid, partially rigid, or flexible. Mechanisms for longitudinally translating first layer 100 with respect to second layer 120 may be created by providing grooves or slots for sliding one or both of layers 100 and 120, rollers for facilitating longitudinal motion of one or both of layers 100 and 120, and levers or wheels for facilitating a user's control of such longitudinal movement of one or both of layers 100 and 120. Additional mechanisms providing for such longitudinal movement of layers 100 and 120 are discussed hereinbelow, in particular with reference to FIG. 4. Layers 100 and 120 are preferably provided with a plurality of polarizing areas of equal width, polarization orientation of each of these areas differing from polarization orientation of an adjacent area by a standard angular difference. A stopping mechanism may be provided, for arresting movement of layer 100 with respect to layer 120 at positions wherein an area of layer 100 is aligned with an area of layer 120.

Device 90, so constituted, is operable to control the ratio of the incident light transmitted by device 90 to the incident light blocked by device 90.

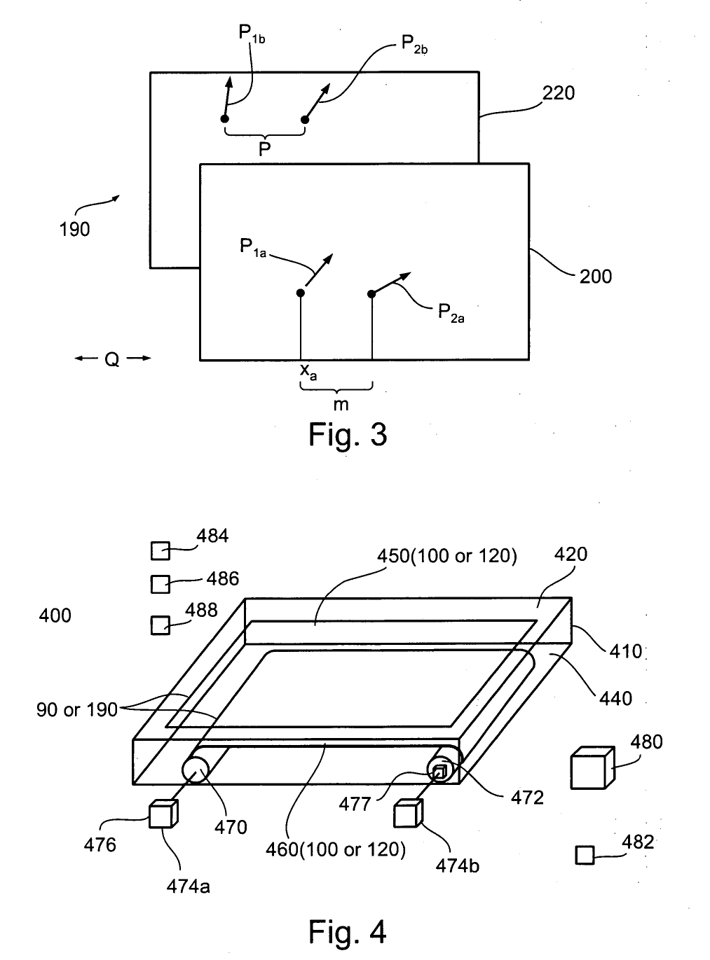

Attention is now drawn to FIG. 3, which presents a further alternative construction for a controllably variable light blocking device, according to an embodiment of the present invention.

FIG. 3 presents a device 190 which is similar in purpose and design to device 90, but wherein changes in polarization orientation across its component layers is gradual and continuous, therein differing from the stepwise changes of layers 100 and 120 of device 90. Device 190 comprises polarizing layers 200 and 220. Layers 200 and 220 are polarizers of continuously variable polarization orientation such as may be produced by the methods of American Polarizers Inc., or by similar methods.

Layer 200 is characterized by a continuous gradual change in angle of polarization orientation of its polarizing material, as measured in a direction Q across layer 200, such that if P₁ₐ is a first angle of orientation of polarization measured at a first position xₐ, and P₂ₐ is a second angle of orientation of polarization measured at a second position (xₐ₊ₘ), then difference (P₁ₐ−P₂ₐ) is constant over all positions of xₐ for any given distance m, and increases as m increases.

Layer 220 is similarly characterized by a continuous gradual change in angle of polarization orientation of its polarizing material, as measured in a direction Q across layer 220, such that if P_{1b} is a first angle of orientation of polarization measured at a first position x_{b}, and P_{2b} is a second angle of orientation of polarization measured at a second position (x_{b+p}), then difference (P_{1b}−P_{2b}) is constant over all positions of x_{b} for any given distance p, and increases as p increases.

Of course, since P₁ₐ and P₂ₐ and P_{1b} and P_{2b} are angular values and therefore cyclical, an increase to e.g. 380° will appear as a measurement of 20°, but should be read as 380° for purposes of this definition.

Device 190 is further characterized by the fact (P₁ₐ−P₂ₐ)=(P_{1b}−P_{2b}) when m=p.

Device 190 comprises means permitting translation of layer 200 with respect to layer 220 along direction Q.

Thus, layer 200 and layer 220 each comprises a polarizing surface of continuously variable polarization orientation. Layers 200 and 220 may be described in a Cartesian space in which an x axis corresponds to a direction Q, a direction in which device 190 is operable to translate layer 200 with respect to layer 220.

Then if

A1 is a point on one of layers 200 and 220 positioned at (x1, y1),

A2 is a point on one of layers 200 and 220 positioned at (x2, y2),

A3 is a point on one of layers 200 and 220 positioned at (x3, y3),

A4 is a point on one of layers 200 and 220 positioned at (x4, y4), and if

polarization orientation at A1 is P1, polarization orientation at A2 is P2, polarization orientation at A3 is P3, and polarization orientation at A4 is P4, and

A1 and A2 are both on layer 200 or both on layer 220 and A3 and A4 are both on layer 200 or both on layer 220, then for all selections of points such that (x2−x1)=(x4−x3), angular difference (P2−P1) equals angular difference (P4−P3).

Thus, it is further possible to manufacture a controlled transparency device by assembling first polarizing layer 200, second polarizing layer 220, and a mechanism for longitudinally translating first layer 200 with respect to second polarizing layer 220. Device 190, so constituted, is operable to control the ratio of the incident light transmitted by device 190 to the incident light blocked by device 190.

Devices 90 and 190 may be constructed in such a manner that small physical displacements of layer 120 with respect to layer 100, or of layer 220 with respect to layer 200, produces a large change in the light transmittance, or alternatively in such a manner that large physical displacements of layer 120 with respect to layer 100, or of layer 220 with respect to layer 200, are required to produce a large change in the light transmittance. Constructions requiring only small movements are advantageous in that if only small displacements are required to run through a range from minimum to maximum light transmittance, little extra space need be provided to enable translational movements of the layers, and relatively little energy is required to perform such movements. However, in such constructions, mutual alignment of layers must be relatively accurate, and fine control of light transmittance requires fine control of translational movements. In contrast, constructions wherein large displacements are required to produce large changes in transmittance require more room to accommodate movement of layers one with respect to another, and more energy to produce such movements, but may enable finer control of transmittance with relatively simple mechanisms for producing those movements. An example of an application for which a small-movement construction is preferable is provided by the sun-glasses application shown in FIG. 8. An example of an application for which a large movement construction may be preferable is provided by FIG. 4, discussed hereinbelow.

Attention is now drawn to FIG. 4, which presents a simplified schematic of a window providing controlled light transmittance, according to an embodiment of the present invention.

FIG. 4 presents an embodiment of device 90, but it is to be understood that the concept presented in FIG. 4 can be implemented as an embodiment of device 190 as well. In general, FIGS. 4-8 and discussions thereof hereinbelow may be understood to refer to devices 90 and 190 interchangeably, with the understanding that devices 90, will in most embodiments (embodiments having visibly resolvable sized areas on layers 100 and 120) require a stopping mechanism 140, whereas devices 190 will not.

FIG. 4 presents a window 400, which comprises a frame 410, a first transparent layer 420, a layer 100, a layer 120, and a second transparent layer 440. First and second transparent layers 420 and 440 may be embodied as layers of glass or plastic, or any similar material appropriate for a window. In a preferred embodiment, one of layers 100 and 120 is a fixed layer, here designated layer 450, and the other of layers 100 and 120 is implemented as a movable flexible layer here designated layer 460. As may be seen from FIG. 4, layer 460 is designed and constructed to be sufficiently flexible at its extremities to enable it to be rolled around rollers 470 and 472. Rollers 470 and 472 are connected to turning devices 474a and 474b, which may be cranks or handles or strings or wires wrapped around rollers 470 and 472, or an electrically controlled motor 476, or any other device operable to rotate rollers 470 and 472. In use, an operator operates turning device 474a to rotate roller 470, thereby pulling layer 460 towards roller 470, or operates turning device 474b to rotate roller 472, thereby pulling layer 460 towards roller 472. The effect of these operations is to effect a displacement of layer 460 with respect to layer 450, thereby effecting displacement of a layer 100 with respect to layer 120 (or of layer 200 with respect to layer 220), thereby controllably modifying light transmittance of window 400. Alternatively, turning device 474a may work against a spring-loaded tension device 477, which acts to maintain tension in layer 460 and enables control of movement of layer 460 from only one turning device (474a), turning device 474a being equipped with a catch and release mechanism operable to lock layer 460 into a selected position. The arrangement thus enables a user to pull layer 460 towards roller 470 to a desired extent, and then to release layer 460 to roll back towards roller 472 when desired, pulled by tension device 477.

In a preferred embodiment, window 400 is sealed, such that the internal mechanism providing for displacement of layer 460 with respect to layer 450 is sealed and thereby protected from dust, such that internal parts of window 400 do not require cleaning nor maintenance, and only external surfaces of transparent layers 420 and 440 require cleaning, like any normal window. Alternatively, window 400 may be partially sealed, or unsealed, with openings permitting passage of air for pressure equalization or aeration.

In a preferred embodiment, window 400 is designed and constructed to function as a curtain wall appropriate for high-rise constructions.

In an alternative construction of window 400, fixed layer 450 may be combined with one of transparent layers 420 and 440, e.g. by attaching polarizing material to, or depositing polarizing material on, a glass substrate.

In a further alternative construction (not shown), a second flexible layer may be provided in place of fixed layer 450, constructed in flexible moveable format similar to that described above for 460, similarly with a set of rollers at each end of that second flexible layer, preferably with a mechanical linkage provided between rollers 470/472 and rollers at the extremities of that second flexible layer, which linkage provides that when layer 460 is induced by a user to move in a first direction, that second flexible layer is induced by that mechanical linkage to move in an opposite direction.

In yet a further alternative construction, it is noted that device 90 and device 190 may be implemented as sealed windows, having rigid rather than flexible layers 100 and 120 (or 200 and 220), and using a mechanical device similar to rollers 470/472, or another mechanical device, to effect translation of layer 100 (or 200) with respect to layer 120 (or 220).

In preferred embodiments, window 400 is embodied as an aircraft window and a nautical vessel window.

In a preferred embodiment, window 400 is embodied as a space divider for an “open space” office environment, operable to provide transparency and alternatively operable to provide a selected degree of opacity, for privacy or freedom from distraction.

Referring again to FIG. 4, in a preferred embodiment turning device(s) 474 is one or more motors 476 capable of controlled displacements, such as a stepper motor. Motor 476 is preferably controlled by a controller 480, operable to activate motor 476 in response to operator commands supplied by wired or wireless control, such as an infra-red remote control 482. In a particularly preferred embodiment, controller 480 is further operable to activate motor 476 in an algorithmically controlled response to readings from one or more thermal sensors 484 and/or visible light sensors 486 and or ultraviolet light sensors 488 communicating with controller 480 through wired or wireless communication. In a preferred embodiment, controller 480 is operable to decrease transmittance of window 400 when a sensor 484 or 486 or 488 detects that a radiation level or heat level or light level (e.g. a level of heat or light or UV detected within a building) has exceeded a predetermined level. Controller 480 may similarly be operable to increase transmittance of window 400 when a sensor 484 or 486 or 488 detects a radiation level inferior to a predetermined level. Similarly, controller may be operable to decrease or increase transmittance of window 400 as a function of a ratio of detected radiation at two or more sensors. In a preferred embodiment, controller 480 reduces transmittance, to preserve privacy, when light levels measured inside a building are greater than those measured outside that building (these being conditions which enable viewers outside a building to see inside through that building's windows), and increases transmittance when light levels outside a building are greater than those measured inside the building (e.g. in daylight), these being conditions in which inhabitants of a building find it congenial to look outside, while outsiders cannot easily see inside.

It is to be noted that although motor 476, controller 480, remote control 482, and sensors 484, 486 and 488 are presented in association with window 400, it is to be understood that these elements may be associated with any other embodiment of device 90 or device 190, and that their association with window 400 is exemplary and not intended to be limiting.

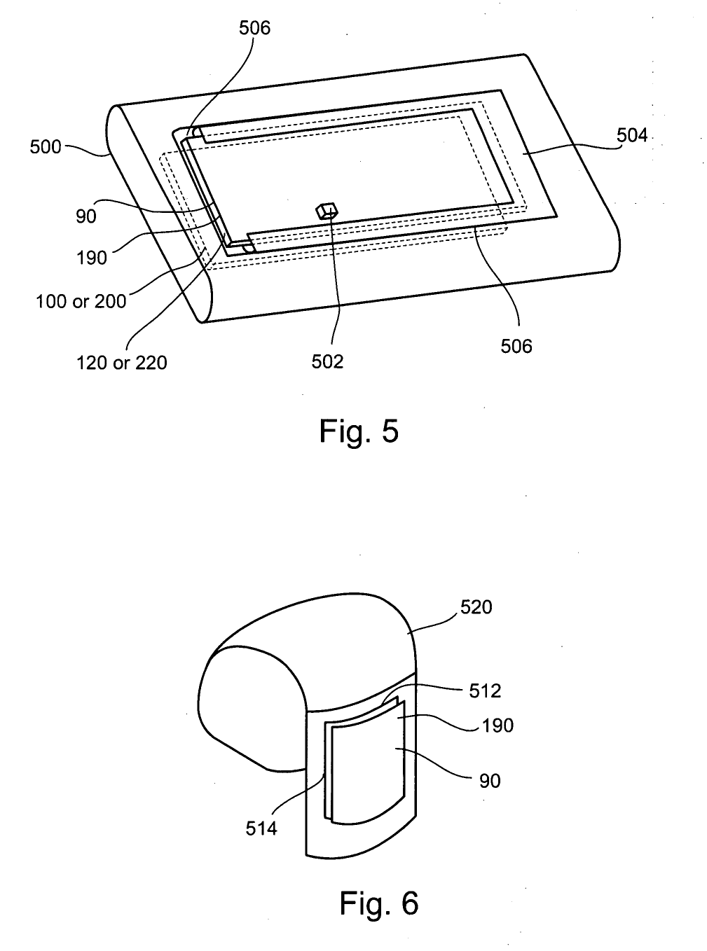

Attention is now drawn to FIGS. 5-8, which present additional exemplary uses of devices 90 and 190, according to preferred embodiments of the present invention.

FIG. 5 presents a device 90 or device 190 used as a sun visor 500 for a vehicle, enabling a driver to shield his eyes from glare while driving towards a low sun or other strong source of light. Visor 500 enables a driver to select a degree of transmittance of visor 500 according to his preferences and according to driving conditions of the moment. A sliding tab 502 enables a driver to slide a moveable first layer (120 or 220) sideways over a fixed second layer (100 or 200) to adjust transmittance of visor 500. A groove 506 is provided to enable layer 120/220 to slide, and space 504 is provided within visor 500 to accommodate layer 120/220, thereby enabling free sliding movement of that moveable first layer.

FIG. 6 presents a device 90 or 190 used as a welding helmet visor 520. Welding helmet visor 520 is preferably constructed as described for vehicle sun visor 500, and similarly enables a user to control light transmittance, thereby making visor 520 adaptable according to personal preferences of a user and according to changing welding conditions. Visor 520 may include independent ultraviolet filter 512 and/or infra-red filter 514, enabling a user to maintain protection from heat and ultraviolet radiation, while varying amounts of visible light received according to his needs and desires, within an acceptable range of transmittance.

FIGS. 7a and 7b present a device 90 or 190 used as a removable mirror dimmer 600 to a rear-view mirror of an automobile or other vehicle, according to a preferred embodiment of the present invention. Mirror dimmer 600 is designed to selectively protect a driver from glare from headlights of following vehicles, while enabling that driver to adjust transmittance of a rear view mirror, selecting a degree of transmittance appropriate to his tastes, his visual acuity, and his recovery time in response to glare (his “night vision”). Mirror dimmer 600 is preferably operable to be removed from a driver's field of vision of his rear-view mirror when not needed.

In a preferred construction shown in FIGS. 7a and 7b, mirror dimmer 600 is designed to clip onto an ordinary rear view mirror 602 of a vehicle, using a pair of flexible clips 604, or similar attaching device. FIG. 7a presents a simplified version of mirror dimmer 600, showing approximate proportional sizes of its elements mounted on a rear-view mirror. Additional features are presented FIG. 7b, which presents, in slightly expanded format, various optional elements dimmer 600. A portion of a frame 610 is shown: frame 610 provides grooves for holding and sliding of layers 100 and 120 of device 90, or layers 200 and 220 of device 190. Although for clarity only a portion of frame 610 is shown in FIG. 7b, frame 610 preferably encloses all of device 90/190. Frame 610 has been removed on the left side of the FIG. 7b, to show adjusting wheel assembly 612, normally held in place by frame 612, which comprises a finger knob 614 for turning by a user, and an adjustment wheel 618 which, engaging layers of device 90/190 by friction or, preferably, by rack and pinion engagement, is operable to move those layers one with respect to each other, and thereby control transmittance of light to and from mirror 602. In the embodiment presented in FIG. 7b, translation of those layers (direction Q) is vertical; areas 110 and 130 extend horizontally across device 90 in this case.

In another preferred construction (not shown), mirror dimmer 600 is permanently attached to a rear view mirror, and is designed to be flipped in front of a rear view mirror for night driving, and to be flipped above or below or behind that mirror for driving in daylight.

Although FIG. 7 has presented a controlled transparency device adapted to an internal rear-view mirror of a vehicle, a similar arrangement can of course be adapted to an external rear-view mirror of a vehicle, or to any other mirror or similar optical device.

FIG. 7 presents a mechanical means for controlling degree of transmittance of the controlled transparency device, but (as shown about in detail with reference to FIG. 4) such a device may also be electronically controlled. In particular, a controller 480 (shown in FIG. 4) may be programmed to control light transmittance of the device as a function of the amount of ambient light, and as a function of the ratio between the amount of light impinging on the mirror from the rear (e.g. from headlights of following vehicles) and the amount of ambient light. A device 90/190 thus controlled is operable to obscure rear vision when a driver is exposed to glaring headlights at night, but to permit maximum transmittance when no glaring following headlights, or only weak or distant headlights, are present.

FIG. 8 presents a set of sunglasses 700 incorporating a device 90 or a device 190, according to a preferred embodiment of the present invention. Construction of light-transmittance adjustable sunglasses 700 is similar to that described for the various embodiments presented hereinabove. As shown in FIG. 8, sunglasses 700 presents a pair of fixed layers 100 (or 200) and a pair of movable layers 120 (or 220), movable layers 120 (or 220) being joined by a connecting bar 710 which supports movable layers 120 (or 220) and engages adjusting wheel assembly 612, so that wheel 612, through bar 710, can control both movable layers 120 (or 220).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each inidividual publication, patent or patent application was specifically and individually indicated to be incorporated herein by reference. In addition, citation or identification of any reference in this application shall not be construed as an admission that such reference is available as prior art to the present invention.

What is claimed is:

1. A controlled transparency device operable to control a ratio of incident light transmitted by the device to incident light blocked by the device, comprising:
(a) a first polarizing layer;
(b) a second polarizing layer; and
(c) a mechanism for translating said first and/or said second polarizing layers longitudinally with respect to one another, so as to control said ratio of the incident light transmitted by the device to the incident light blocked by the device.

2. The device of claim 1, embodied as a window.

3. The device of claim 2, embodied as a window of an aircraft.

4. The device of claim 2, embodied as a window of a marine vessel.

5. The device of claim 2, embodied as a space divider for office buildings.

6. The device of claim 1, embodied as a curtain wall.

7. The device of claim 1, embodied as a visor for welding.

8. The device of claim 1, embodied as a dimmer for a mirror.

9. The device of claim 8, where said dimmer is detachable.

10. The device of claim 8, where said mirror is a rear-view mirror of a vehicle.

11. The device of claim 1, embodied as a sun visor for a vehicle.

12. The device of claim 1, wherein each of said first and second polarizing layers comprises a plurality of polarizing areas of equal width, and wherein polarization orientation of each of said areas on each of said first and second layers differs from polarization orientation of an adjacent area by a standard angular difference.

13. The device of claim 12, wherein said mechanism comprises a stopping mechanism whereby movement of said first layer with respect to said second layer is arrested at positions wherein an area of said first layer is aligned with an area of said second layer.

14. The device of claim 12, wherein said standard width of said polarizing areas is smaller than 2 mm.

15. The device of claim 12, wherein said standard width of said polarizing areas is such that if a light source is present on a first side of said device and if areas of said first layer are so positioned as to be misaligned with areas of said second layer, light and dark patterns thereby created by said device are too small to be resolved by a human eye positioned at anticipated user distance on a second side of said device.

16. The device of claim 12, wherein said areas are formed as rectangular strips.

17. The device of claim 12, wherein said areas are formed as parallelograms.

18. The device of claim 12, wherein said areas are formed as curved strips.

19. The device of claim 1, wherein each of said first and second polarizing layers comprises a polarizing surface of continuously variable polarization orientation, such that if said first and second layers are described in a Cartesian space in which an x axis corresponds to said direction of longitudinal translation of said first layer with respect to said second layer, and
A1 is a point on one of said first and second layers positioned at x1, y1 having a polarization orientation at angle P1,
A2 is a point on one of said first and second layers positioned at x2, y2 having a polarization orientation at angle P2,
A3 is a point on one of said first and second layers positioned at x3, y3 having a polarization orientation at angle P3,
A4 is a point on one of said first and second layers positioned at x4, y4 having a polarization orientation at angle P4,
P1 and P2 being on a same one of said first and second layers and P3 and P4 being on a same one of said first and second layers,
then for all selections of points such that (x2−x1)=(x4−x3), angular difference (P2−P1) equals angular difference (P4−P3).

20. The device of claim 1, wherein said mechanism comprises a lever usable to effect translation of said first layer with respect to said second layer.

21. The device of claim 1, wherein said mechanism comprises a wheel usable to effect translation of said first layer with respect to said second layer.

22. The device of claim 1, further comprising a motor usable to effect translation of said first layer with respect to said second layer.

23. The device of claim 22, wherein said motor is operable to be controlled by a controller.

24. The device of claim 23, wherein said controller is operable to receive data from a sensor, and further operable to select a command for said motor, said selection being at least partially based on said received data.

25. The device of claim 24, further comprising at least one sensor.

26. The device of claim 24, wherein said sensor is a heat sensor.

27. The device of claim 24, wherein said sensor is a light sensor.

28. The device of claim 1, wherein said first layer is rigid, and at least a portion of said second layer is flexible.

29. The device of claim 1, wherein said first and second layers are rigid.

30. The device of claim 1, wherein at least a portion of said first layer is flexible and at least a portion of said second layer is flexible.

31. The device of claim 1, wherein at least one of said first and second layers comprises a flexible portion.

32. The device of claim 31, embodied as a sealed window.

33. The device of claim 31, embodied as a sealed window.

34. The device of claim 31, wherein said flexible portion is operable to be rolled on a roller.

35. The device of claim 34, wherein said roller is operable to be rotated by a user.

36. The device of claim 34, wherein said roller is operable to be rotated by a motor controlled by a user.

37. The device of claim 36, wherein said motor is operable to be controlled by a user by means of a wireless remote control.

38. The device of claim 34, wherein each of said first and second layers comprises a flexible portion operable to be rolled on a roller.

39. A method of manufacturing a controlled transparency device operable to control a ratio of incident light transmitted by the device to incident light blocked by device, the method comprising assembling a first polarizing layer; a second polarizing layer; and a mechanism for translating said first and/or said second polarizing layers longitudinally with respect to one another, so as to control said ratio of the incident light transmitted by the device to the incident light blocked by the device, thereby manufacturing the controlled transparency device operable to control the ratio of the incident light transmitted by the device to the incident light blocked by device.

40. The method of claim 39, further comprising providing on each of said first and second polarizing layers a plurality of polarizing areas of equal width, polarization orientation of each of said areas on each of said first and second layers differing from polarization orientation of an adjacent area by a standard angular difference.

41. The method of claim 40, further comprising providing a stopping mechanism for arresting movement of said first layer with respect to said second layer at positions wherein an area of said first layer is aligned with an area of said second layer.

42. The method of claim 39, further comprising providing on each of said first and second polarizing layers a polarizing surface of continuously variable polarization orientation, such that if said first and second layers are described in a Cartesian space in which an x axis corresponds to said direction of longitudinal translation of said first layer with respect to said second layer, and
A1 is a point on one of said first and second layers, positioned at x1, y1 having a polarization orientation at angle P1,
A2 is a point on one of said first and second layers positioned at x2, y2 having a polarization orientation at angle P2,
A3 is a point on one of said first and second layers positioned at x3, y3 having a polarization orientation at angle P3,
A4 is a point on one of said first and second layers positioned at x4, y4 having a polarization orientation at angle P4,
P1 and P2 being on a same one of said first and second layers and P3 and P4 being on a same one of said first and second layers,
then for all selections of points such that (x2−x1)=(x4−x3), angular difference (P2−P1) equals angular difference (P4−P3).

43. The method of claim 39, further comprising providing a motor usable to effect translation of said first layer with respect to said second layer.

44. The method of claim 43, further comprising providing a controller operable to control operation of said motor and further operable to receive input from at least one of a group consisting of a human operator, an infra-red sensor, a visible light sensor, and an ultra-violet light sensor.

45. The method of claim 39, further comprising embodying said controlled transparency device in one of a group consisting of a window, a sealed window, a space divider for office buildings, a curtain wall, a visor for welding, a dimmer for a mirror, and a sun visor for a vehicle.
